(19) United States
(12) Patent Application Publication
(10) Pub. No.: US 2025/0141642 A1
(43) Pub. Date: May 1, 2025

(54) VIRTUAL CELL CONFIGURATION AND OPERATION

(71) Applicant: QUALCOMM Incorporated, San Diego, CA (US)

(72) Inventors: Jing LEI, San Diego, CA (US); Kazuki TAKEDA, Tokyo (JP); Kianoush HOSSEINI, San Diego, CA (US)

(21) Appl. No.: 18/499,935

(22) Filed: Nov. 1, 2023

(51) Int. Cl. H04L 5/00; H04L 1/1607; H04W 72/232

(52) U.S. Cl. CPC H04L 5/0094; H04L 1/1614; H04W 72/232

(57) ABSTRACT

Certain aspects of the present disclosure provide techniques for configuring and operating virtual cells including virtual cells operating in non-contiguous subbands. A method that may be performed by a user equipment (UE) includes: receiving signaling indicating a plurality of non-contiguous subbands configured for a virtual cell; and communicating in the virtual cell via the non-contiguous subbands.

### BACKGROUND

### Field of the Disclosure

Aspects of the present disclosure relate to wireless communications, and more particularly, to techniques for configuring and operating virtual cells including virtual cells operating in non-contiguous subbands.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving signaling indicating a plurality of non-contiguous subbands configured for a virtual cell; and communicating in the virtual cell via the non-contiguous subbands.

Another aspect provides a method for wireless communications by a network entity. The method includes configuring a plurality of non-contiguous subbands for downlink (DL) or uplink (UL) operations for a virtual cell; and communicating the configuration of the virtual cell.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example of aggregating non-contiguous frequency bands.

FIG. 6 depicts an example of non-contiguous refarmed spectrum.

FIG. 7 depicts a portion of a table of channel bandwidths for NR communications systems

FIG. 8 depicts an example usage of RF spectrum.

FIG. 9 depicts a process flow for communications in a network.

FIG. 10 depicts an example of non-contiguous subbands configured for a virtual cell.

FIG. 11 depicts an example of a PDCCH being used to schedule other transmissions in a virtual cell using non-contiguous subbands.

FIG. 12 depicts a method for wireless communications.

FIG. 13 depicts a method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for configuring and operating virtual cells including virtual cells operating in non-contiguous subbands.

As used herein, a “subband” refers to a group of sub-carriers that are each separated in frequency from a next sub-carrier by a sub-carrier spacing (SCS). As used herein, “non-contiguous subbands” refers to subbands that are each separated in frequency from the other by a gap (that is larger than an SCS), wherein the gap is not used for a transmission on either of the subbands. As used herein, a “virtual cell” refers to a logical entity in which one or more network entities transmit and/or receive using a (shared) virtual cell identity (VCID) instead of each network entity transmitting and receiving using their physical cell identity (PCI). As used herein, “refarmed spectrum” and “refarmed resources” refer to frequency resources that have at one time been assigned for use with a first radio access technology (RAT) and are assigned for (re-)use with a second RAT at a later time.

Some wireless communications systems, such as sixth generation (6G) cellular technology systems, may not be able to operate on contiguous frequency spectrum with good coverage in all areas when first implemented. In some cases, contiguous frequency spectrum will not be available because of usage of the spectrum by 5G cellular systems or other systems. Spectrum (also referred to herein as frequency resources and RF spectrum) that has been assigned to communications systems using a radio access technology (RAT) may be reassigned or refarmed to other communications systems using a new RAT. Refarmed spectrum may have a narrow bandwidth (BW) and be scattered in frequency. Such refarmed spectrum may be challenging or impossible to leverage for dynamic spectrum sharing or carrier aggregation (CA).

According to aspects of the present disclosure, techniques are provided for virtual cell operation and configuration for sixth generation (6G) and other RATs, including using non-contiguous subbands. As described herein, a virtual cell (e.g., operated by 6G cellular systems and other wireless communications systems) can be configured with non-contiguous subbands. The non-contiguous subbands configured for a virtual cell may belong to a same frequency range, a maximum gap between two adjacent subbands may be defined, and a maximum aggregated bandwidth across all of the configured subbands may also be defined.

Using virtual cells with non-contiguous subbands may overcome restrictions on spectrum refarming and CA, improve the utilization efficiency of fragmented or refarmed resources, and enhance the co-existence of different use cases.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

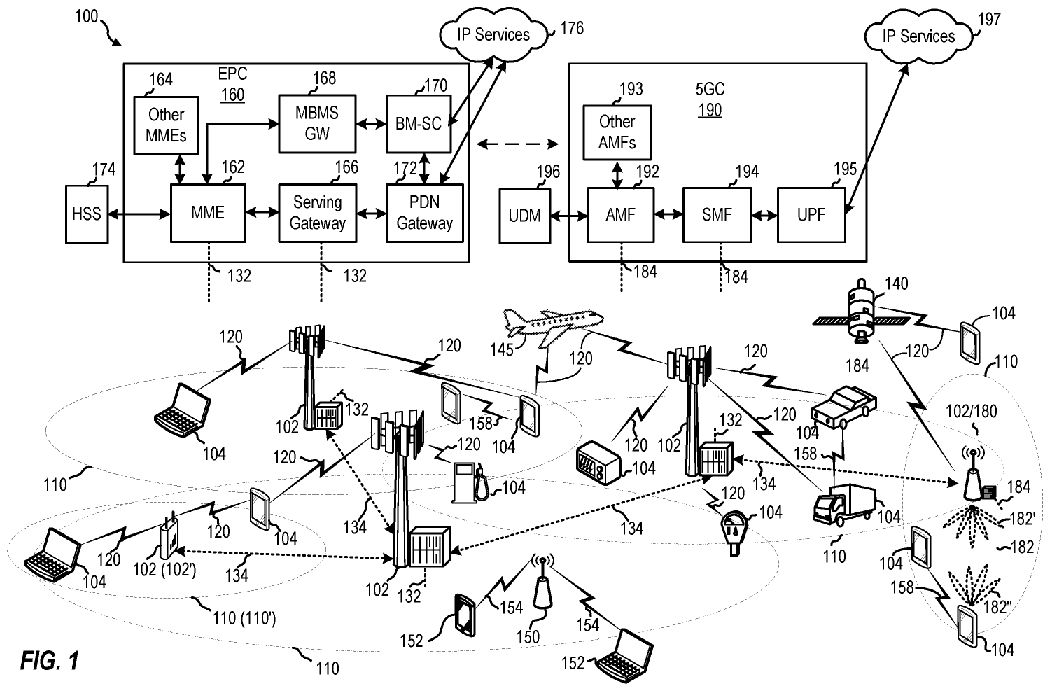

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

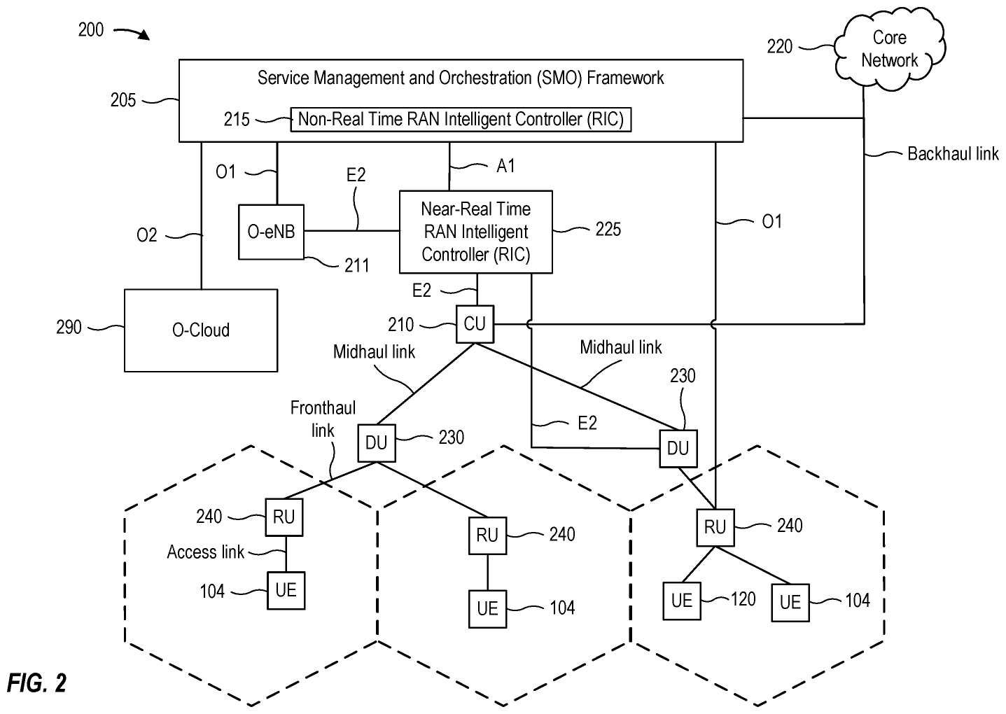

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements, which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240, and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

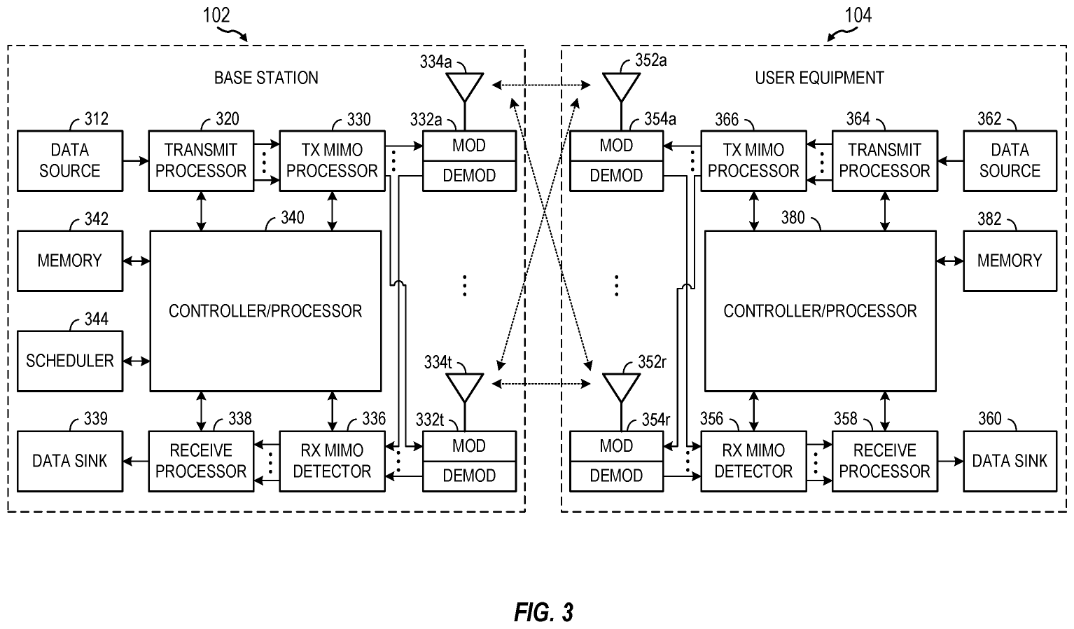

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

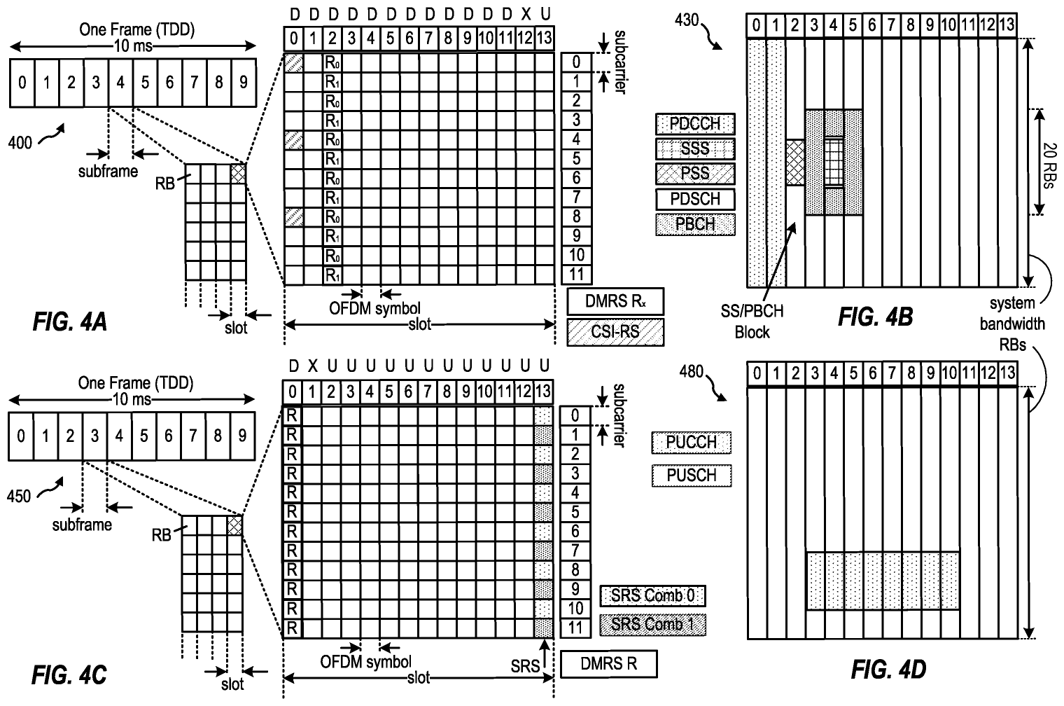

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### QCL Port and TCI States

In many cases, it is important for a UE to know which assumptions it can make on a channel corresponding to different transmissions. For example, the UE may need to know which reference signals it can use to estimate the channel in order to decode a transmitted signal (e.g., PDCCH or PDSCH). It may also be important for the UE to be able to report relevant channel state information (CSI) to the BS (e.g., a gNB) for scheduling, link adaptation, and/or beam management purposes. In NR, the concept of quasi co-location (QCL) and transmission configuration indicator (TCI) states is used to convey information about these assumptions.

QCL assumptions are generally defined in terms of channel properties. Per 3GPP TS 38.214, “two antenna ports are said to be quasi co-located if properties of the channel over which a symbol on one antenna port is conveyed can be inferred from the channel over which a symbol on the other antenna port is conveyed.” Different reference signals may be considered quasi co-located (“QCL′d”) if a receiver (e.g., a UE) can apply channel properties determined by detecting a first reference signal to help detect a second reference signal. TCI states generally include configurations such as QCL-relationships, for example, between the DL RSs in one CSI-RS set and the PDSCH DMRS ports.

In some cases, a UE may be configured with up to M TCI-States. Configuration of the M TCI-States can come about via higher layer signalling, while a UE may be signalled to decode PDSCH according to a detected PDCCH with DCI indicating one of the TCI states. Each configured TCI state may include one RS set TCI-RS-SetConfig that indicates different QCL assumptions between certain source and target signals.

For example, TCI-RS-SetConfig may indicate a source RS in the top block and may be associated with a target signal indicated in the bottom block. In this context, a target signal generally refers to a signal for which channel properties may be inferred by measuring those channel properties for an associated source signal. As noted above, a UE may use the source RS to determine various channel parameters, depending on the associated QCL type, and use those various channel properties (determined based on the source RS) to process the target signal. A target RS does not necessarily need to be PDSCH's DMRS. Rather, a target RS may be any other RS (e.g., PUSCH DMRS, CSIRS, TRS, and SRS).

Each TCI-RS-SetConfig may contain various parameters. These parameters can, for example, configure quasi co-location relationship(s) between reference signals in the RS set and the DM-RS port group of the PDSCH. The RS set contains a reference to either one or two DL RSs and an associated quasi co-location type (QCL-Type) for each one configured by the higher layer parameter QCL-Type.

For the case of two DL RSs, the QCL types can take on a variety of arrangements. For example, QCL types may not be the same, regardless of whether the references are to the same DL RS or different DL RSs. In the illustrated example, SSB is associated with Type C QCL for P-TRS, while CSI-RS for beam management (CSIRS-BM) is associated with Type D QCL.

QCL information and/or types may in some scenarios depend on or be a function of other information. For example, the QCL types indicated to the UE can be based on higher layer parameter QCL-Type and may take one or a combination of the following types:

QCL-TypeA: {Doppler shift, Doppler spread, average delay, delay spread},
QCL-TypeB: {Doppler shift, Doppler spread},
QCL-TypeC: {average delay, Doppler shift}, and
QCL-TypeD: {Spatial Rx parameter},

Spatial QCL assumptions (QCL-TypeD) may be used to help a UE to select an analog Rx beam (e.g., during beam management procedures). For example, an SSB resource indicator may indicate a same beam for a previous reference signal should be used for a subsequent transmission.

An initial CORESET (e.g., CORESET ID 0 or simply CORESET #0) in NR may be identified during initial access by a UE (e.g., via a field in the MIB). A ControlResourceSet information element (CORESET IE) sent via radio resource control (RRC) signaling may convey information regarding a CORESET configured for a UE. The CORESET IE generally includes a CORESET ID, an indication of frequency domain resources (e.g., a number of RBs) assigned to the CORESET, contiguous time duration of the CORESET in a number of symbols, and Transmission Configuration Indicator (TCI) states.

As noted above, a subset of the TCI states provide QCL relationships between DL RS(s) in one RS set (e.g., TCI-Set) and PDCCH demodulation RS (DMRS) ports. A particular TCI state for a given UE (e.g., for unicast PDCCH) may be conveyed to the UE by the Medium Access Control (MAC) Control Element (MAC-CE). The particular TCI state is generally selected from the set of TCI states conveyed by the CORESET IE, with the initial CORESET (CORESET #0) generally configured via MIB.

Search space information may also be provided via RRC signaling. For example, the SearchSpace IE is another RRC IE that defines how and where to search for PDCCH candidates for a given CORESET. Each search space is associated with one CORESET. The SearchSpace IE identifies a search space configured for a CORESET by a search space ID. In an aspect, the search space ID associated with CORESET #0 is SearchSpace ID #0. The search space is generally configured via PBCH (MIB).

### Aspects Related to Configuring and Operating Virtual Cells Including Virtual Cells Operating in Non-Contiguous Subbands

Some wireless communications systems, such as sixth generation (6G) cellular technology systems, may not be able to operate on contiguous frequency spectrum with good coverage in all areas when first implemented. In some cases, contiguous frequency spectrum will not be available because of usage of the spectrum by 5G cellular systems or other systems.

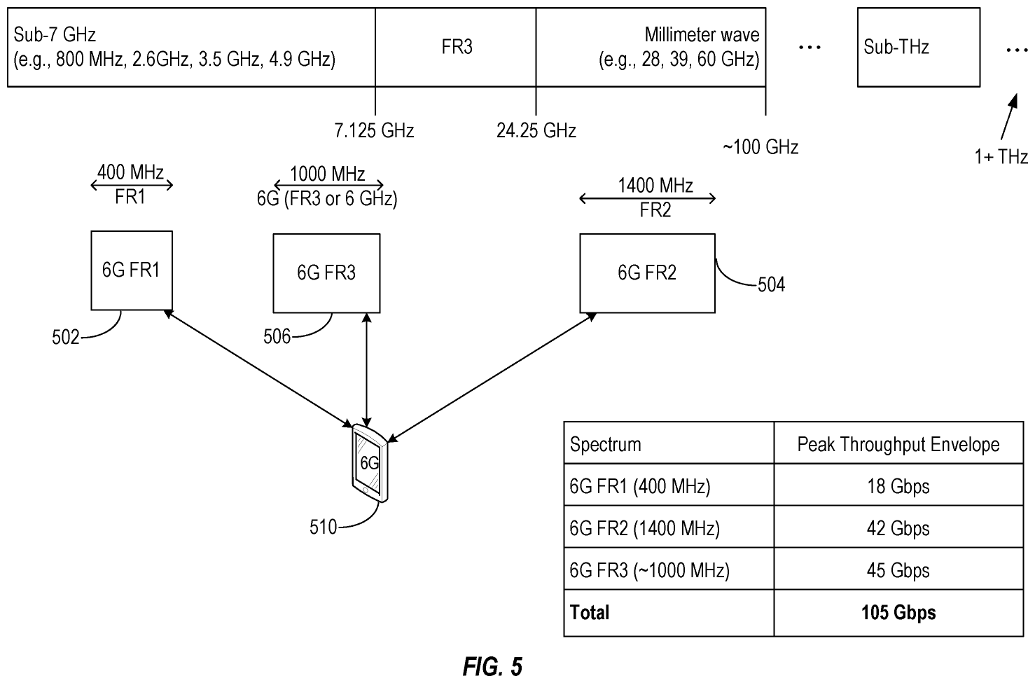

FIG. 5 depicts an example of aggregating non-contiguous frequency bands 502, 504, and 506 in order to theoretically achieve 100 Gbps peak throughput to a UE 510, which may be an example of UE 104 depicted and described with respect to FIGS. 1 and 3 or another type of wireless communications device. As illustrated, a wireless communications system (e.g., a 6G system) may aggregate a 400 MHz frequency band 502, a 1400 MHz frequency band 504, and a 1000 MHz frequency band 506 to achieve 105 Gbps throughput to the UE 510.

In some wireless communications systems (e.g., LTE or 5G systems), for a cell site with one or multiple component carriers (CCs), the system bandwidth (BW) of each CC spans a set of resource blocks that are contiguous in frequency. The size (in BW) of a CC is lower bounded by a minimum channel bandwidth (CBW) of UEs served by the wireless communications system. Minimum CBW of a UE is dependent on the radio access technology (RAT) and hard-coded for each operating band. For example, minimum CBW for an LTE UE is 1.4 MHZ, while the minimum CBW is 5, 10, or 20 MHz NR UEs, depending on the SCS used and the frequency band of the system.

In some aspects of the present disclosure, spectrum (also referred to herein as frequency resources and RF spectrum) that has been assigned to communications systems using a RAT may be reassigned or refarmed to other communications systems using a new RAT. Refarmed spectrum may have a narrow BW and be scattered in frequency. Such refarmed spectrum may be challenging or impossible to leverage for dynamic spectrum sharing or CA. For example, without spectrum aggregation with other CCs to meet a minimum CBW requirement, one or multiple refarmed CCs with BWs of less than 5 MHz will not be suitable for standalone (SA) deployment of NR/5G communications systems.

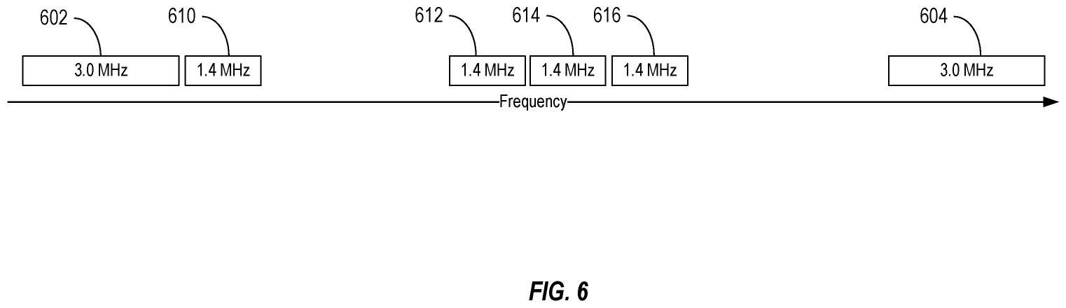

FIG. 6 depicts an example of non-contiguous refarmed spectrum, according to aspects of the present disclosure. As illustrated, a set of two 3-MHz bandwidth blocks 602 and 604 and four 1.4-MHz bandwidth blocks 610, 612, 614, and 616 may be refarmed from a communications system operating with the LTE RAT to be used by another communications system using another RAT.

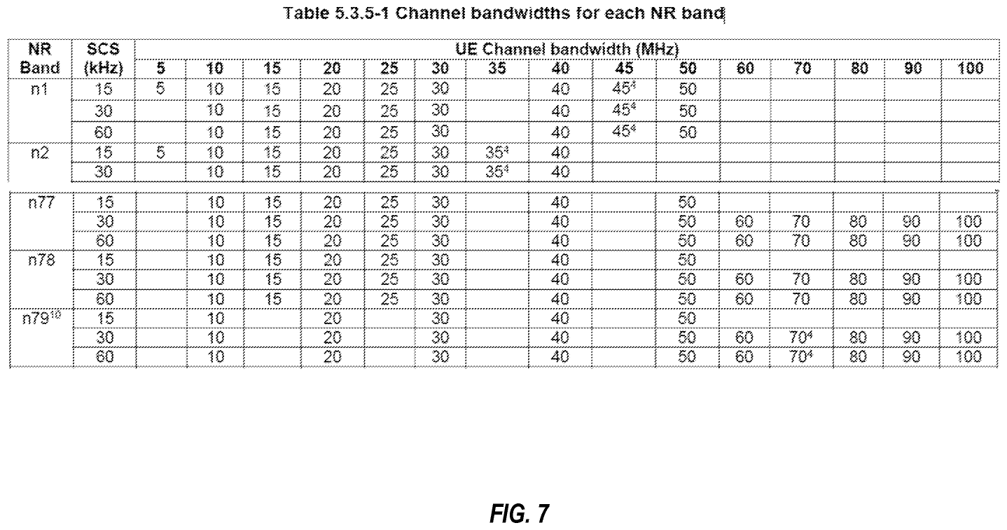

FIG. 7 depicts a portion of a table of channel bandwidths for NR communications systems. As illustrated, possible UE channel bandwidths vary with both the SCS and the frequency band.

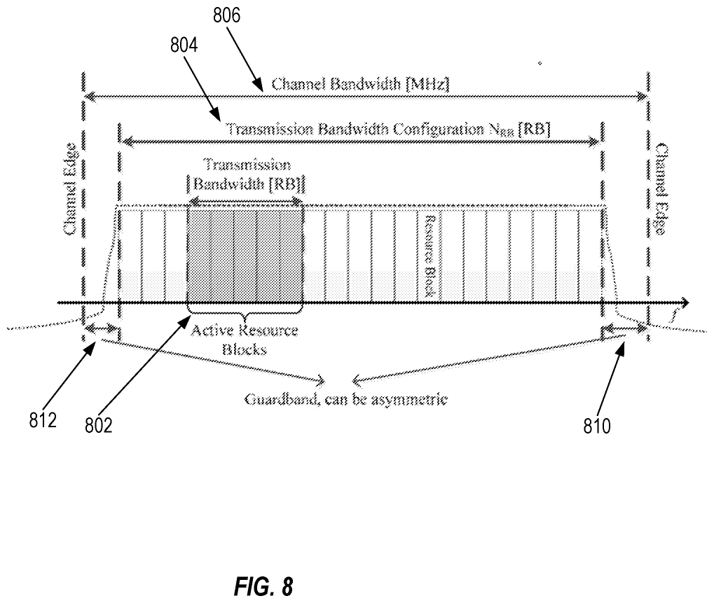

FIG. 8 depicts an example usage of RF spectrum, according to aspects of the present disclosure. A transmitting device (e.g., a UE, BS, or network entity) transmits on a set of active resource blocks 802 within a transmission bandwidth 804 that is within a channel bandwidth 806. The channel bandwidth also includes guardbands 810 and 812 on each side of the transmission bandwidth 804.

According to aspects of the present disclosure, to overcome restrictions on spectrum refarming and CA, improve the utilization efficiency of fragmented or refarmed resources, and enhance the co-existence of different use cases, techniques are provided for virtual cell operation and configuration for 6G and RATs.

### Example Operations of Entities in a Communications Network

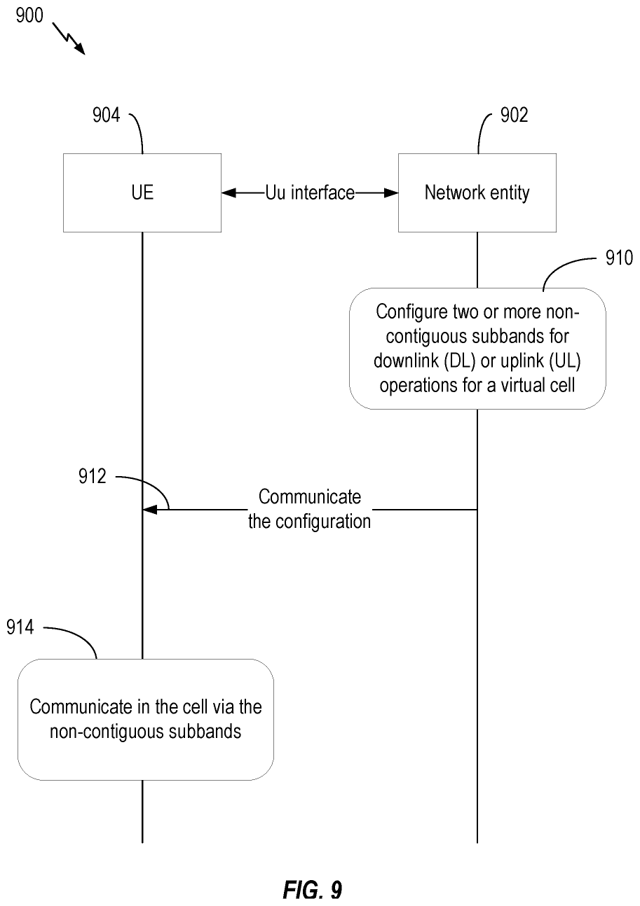

FIG. 9 depicts a process flow 900 for communications in a network between a network entity 902 and a user equipment (UE) 904. In some aspects, the network entity 902 may be an example of the BS 102 depicted and described with respect to FIGS. 1 and 3 or a disaggregated base station depicted and described with respect to FIG. 2. Similarly, the UE 904 may be an example of UE 104 depicted and described with respect to FIGS. 1 and 3. However, in other aspects, UE 104 may be another type of wireless communications device and BS 102 may be another type of network entity or network node, such as those described herein.

At 910, the network entity 902 configures two or more non-contiguous subbands for downlink (DL) or uplink (UL) operations for a virtual cell.

At 912, the network entity 902 communicates the configuration of the virtual cell. In some aspects of the present disclosure, communicating the configuration of the virtual cell includes transmitting the configuration to the UE in system information (SI) or in signaling directed to the UE (e.g., in a UE-specific bandwidth part (BWP) configuration). In some aspects of the present disclosure, communicating the configuration includes sending the configuration to another network entity via a wired or wireless backhaul link.

At 914, the UE communicates in the cell via the non-contiguous subbands. In aspects of the present disclosure, communicating in the cell may include receiving a downlink transmission, transmitting an uplink transmission, transmitting a sidelink transmission, or receiving a sidelink transmission.

According to aspects of the present disclosure, a virtual cell (e.g., operated by 6G cellular systems and other wireless communications systems) can be configured with non-contiguous subbands.

In aspects of the present disclosure, all of the subbands configured for a virtual cell may belong to a same frequency range. For example, the spectrum resources of a virtual cell cannot be mapped to both frequency range 1 (FR1) and frequency range (FR2).

According to aspects of the present disclosure, a gap between two adjacent subbands may be less than a threshold, F_{MGAP} MHz. The threshold, F_{MGAP}, may be pre-configured, i.e., have a value before any subbands are configured.

In aspects of the present disclosure, the aggregated BW across all of the configured subbands may be less than a threshold, F_{MSUM} MHz. The threshold, F_{MSUM}, may be pre-configured.

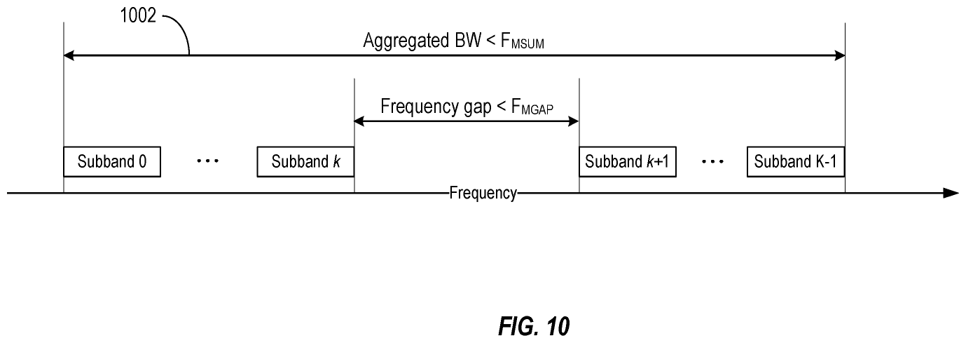

FIG. 10 depicts an example of non-contiguous subbands configured for a virtual cell, according to aspects of the present disclosure. As illustrated, all of the subbands 0 through K−1 configured for the virtual cell are within an aggregated bandwidth 1002 that is less than F_{MSUM}. Also as illustrated, a maximum gap between any two adjacent subbands, such as the gap 1010 between subband k and subband k+1, is less than F_{MGAP}.

According to aspects of the present disclosure, if a physical channel or RS is transmitted or received by the virtual cell across multiple activated subbands, then a same numerology (SCS and CP length) and waveform may be configured for the physical channel or RS on the activated subbands.

In aspects of the present disclosure, a receive time difference (RTD) of DL channels or RS across the activated subbands may be less than a threshold, T_{MRTD}, wherein T_{MRTD}<T_{CP}/L, T_{CP} is the time duration of the CP associated with a reference and/or maximum SCS supported by the virtual cell, and L is an integer greater than 1 that is associated with the reference and/or maximum SCS supported by the virtual cell.

According to aspects of the present disclosure, a same timing advance (TA) value may be applied to an UL channel and/or RS transmitted on the activated subbands.

In aspects of the present disclosure, if a DL RS (e.g., CSI-RS, TRS, or SSB) is transmitted with a same power and/or spatial filter by a virtual cell on multiple subbands, then the difference of the average reception power per activated subband may be controlled to be less than a threshold. P_{MRPD} dB. The threshold, P_{MRPD}, may be pre-configured.

According to aspects of the present disclosure, if a source RS (e.g., SSB, TRS, or CSI-RS) is not configured on a subband being activated, then a UE may assume that RS transmitted and/or received on the activated subband are quasi co-located (QCL′d) with a source RS transmitted by the virtual cell on another activated subband. In such aspects, the source RS may also be used for L1 and/or L3 measurements of the virtual cell.

In aspects of the present disclosure, a frequency location (e.g., a starting PRB index with respect to a reference point), BW, and an index of each subband configured for the virtual cell may be provided in S1.

According to aspects of the present disclosure, when a DL or an UL BWP is configured on the virtual cell, the DL or UL BWP may contain one or more subbands.

In aspects of the present disclosure, a bitmap may be transmitted (e.g., in S1 or in UE-specific signaling) by a network entity to indicate subbands activated in a DL or UL BWP. In these aspects, the length of the bitmap may be equal to the number of subbands configured for the virtual cell.

According to aspects of the present disclosure, a network entity may indicate a lowest index (I_{low}) and a highest index (I_{high}) of subbands that are activated in a DL BWP or an UL BWP, and subbands having indices between I_{low} and I_{high} are also activated in the DL BWP or UL BWP.

In aspects of the present disclosure, a virtual cell can be configured as a primary cell (PCell), a primary cell of a secondary cell group (PSCell), or a secondary cell (SCell). In some aspects, such a virtual cell may be configured with one HARQ entity.

According to aspects of the present disclosure, when a PDSCH is scheduled (e.g., by a network entity) for a single transport block (TB) or code block group (CBG), the PDSCH may be transmitted by a network entity on a single subband or across multiple subbands in the active DL BWP. The PDSCH may be transmitted with or without frequency hopping, when transmitted across multiple subbands.

In aspects of the present disclosure, when a PUSCH is scheduled (e.g., by a network entity) for a single TB or CBG, the PUSCH may be transmitted by a UE on a single subband or across multiple subbands with frequency hopping in the active UL BWP.

According to aspects of the present disclosure, if the virtual cell is a scheduling cell, at least a CORESET may be configured within a DL BWP on a single subband or across multiple subbands in a DL BWP.

In aspects of the present disclosure, a DCI with a format similar to a Rel18 MC-scheduling DCI may be used to support DL and/or UL scheduling across multiple subbands.

According to aspects of the present disclosure, a DCI may include a frequency domain resource allocation (FDRA) field that applies to all of the scheduled subbands. Such a DCI may have lower overhead than a DCI including subband-specific FDRA fields.

According to aspects of the present disclosure, a DCI may include subband-specific FDRA fields. Such a DCI may enable more flexible resource management than a DCI having an FDRA field that applies to all of the scheduled subbands.

In aspects of the present disclosure, random access (RA) resources for contention-based random access (CBRA) and contention-free random access (CFRA) may be configured on a single subband or across multiple non-contiguous subbands.

According to aspects of the present disclosure, a subband specific offset may be used for frequency domain indexing of random access opportunities (ROs) and random access radio network temporary identifier (RA-RNTI) calculation. Using such a subband specific offset may enable traffic offloading from other subbands, co-existence enhancement of different use cases, and improve collision avoidance for RA transmissions.

According to aspects of the present disclosure, random access response (RAR) and contention resolution messages may be scheduled on a subband different from a DCI scheduling the RAR and contention resolution messages. Using different subbands may improve frequency diversity gain and enable traffic offloading when compared with systems using the same subband for the DCI, RAR, and contention resolution messages.

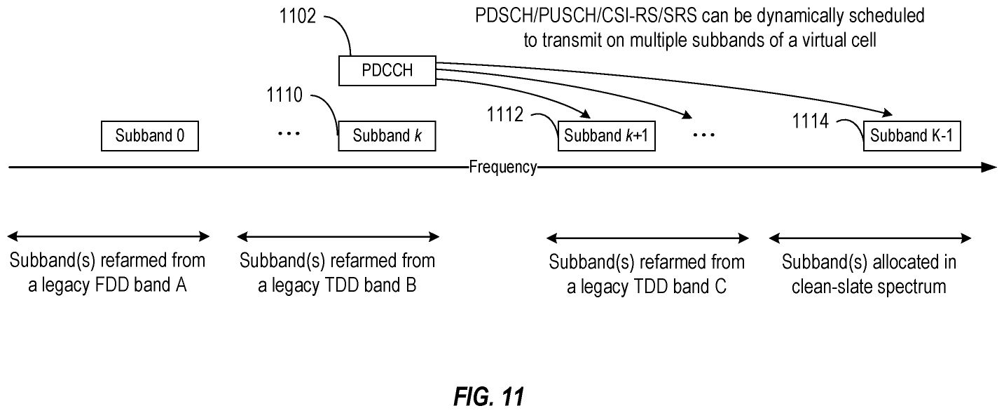

FIG. 11 depicts an example of a PDCCH being used to schedule other transmissions in a virtual cell using non-contiguous subbands, according to aspects of the present disclosure. As illustrated, a PDCCH 1102 in a first subband 1110 may schedule a PUSCH, CSI-RS, SRS, or other transmission on other subbands 1112 or 1114 of a virtual cell. The frequency spectrum of the subbands may be refarmed from other uses or newly allocated.

As illustrated in FIG. 11, K>1 subbands that do not overlap in frequency may be configured for a virtual cell. The subbands may be indexed from 0 to K−1 in ascending order of frequency.

According to aspects of the present disclosure, BWP configuration in a virtual cell using non-contiguous subbands may be indicated by a bitmap of length=K. The bitmap may be used to indicate activated subbands in a BWP, providing flexibility for scheduling and interference management. For example, a bitmap [0 1 0 1 1 0] indicates that subbands having indexes 1, 3, and 4 will be or are activated in the BWP, but subbands 0, 2, and 5 will not or are not activated in the BWP.

In aspects of the present disclosure, activated subbands in a BWP will have consecutive indexes from a low index (I_{low}) through a high index (I_{high}). For example, I_{low}=1 and I_{high}=3 indicates that subbands having indexes by 1, 2, and 3 will be or are activated in the BWP, and other subbands will not or are not activated in the BWP.

According to aspects of the present disclosure, cross-subband scheduling may be supported for DL and/or UL BWPs. In such aspects, the scheduling and/or configuration information may be provided in a DCI, medium access control (MAC) control element (CE), and/or via RRC signaling. An FDRA field in the DCI, MAC-CE, or RRC signaling may include indexes to configured or activated subbands. Based on the virtual cell (or BWP) configuration, the RB or RB groups (RBGs) across configured or activated subbands can be indexed consecutively. Thus, a last RB or RBG index in subband k may be followed by a first RB or RBG index in sub-band (k+1).

According to aspects of the present disclosure, a virtual cell can integrate spectrum refarmed from one or more TDD bands and/or one or more FDD bands.

In aspects of the present disclosure, a UE may operate in a full-duplex (simultaneous TX and RX) mode on a pair of activated BWPs (e.g., a DL BWP and an UL BWP), if the UE is full-duplex-capable (i.e., the UE is equipped with a duplexer and separate chains for TX/RX processing), a frequency gap between activated subbands for transmission and reception is greater than or equal to a threshold duplexing gap, a frequency gap between activated subbands is vacant (e.g., not reserved for another RAT), and the active DL BWP and the active UL BWP do not share an activated subband. In such aspects, the threshold duplexing gap may be pre-configured.

According to aspects of the present disclosure, a UE may be triggered to change from half-duplex mode to full-duplex mode by BWP switching (e.g., a change from a first set of subbands in an active BWP to a second set of subbands).

In aspects of the present disclosure, if the frequency gap between a pair of activated subbands is not vacant (e.g., the frequency gap is reserved for use by another RAT), then whether full-duplex operation is supported may depend on the size of the frequency gap, the amount of guard band required between different RATs, and capabilities of a UE.

According to aspects of the present disclosure, on a pair of activated BWPs (e.g., a DL BWP and an UL BWP) configured with complementary D/U split patterns (e.g., all DL/UL or interlaced DL/UL) in TDD, a UE can report capabilities for different duplex modes. The UE may report to a network entity one or more of the capabilities: full-duplex capable, Type-A half-duplex capable, or Type-B half-duplex capable. When reporting that the UE is full-duplex capable, the UE is capable of simultaneous transmission and reception (e.g., the UE has separate transmit and receive chains and a duplexer for TX/RX processing). When reporting that the UE is Type-A half-duplex capable, the UE is not capable of simultaneous transmission and reception and can switch from transmission to reception or vice-versa after a short switching gap (e.g., the UE has separate local oscillators for transmission and reception, but no duplexer). When reporting that the UE is Type-B half-duplex capable, the UE is not capable of simultaneous transmission and reception and can switch from transmission to reception or vice-versa after a large switching gap (e.g., the UE has a shared local oscillator for transmission and reception.

### Example Operations

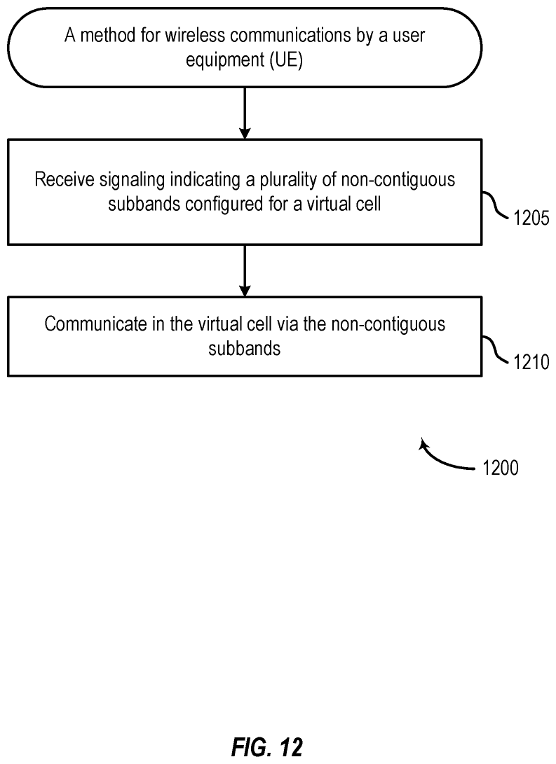

FIG. 12 shows an example of a method 1200 of wireless communications by a user equipment (UE), such as a UE 104 of FIGS. 1 and 3.

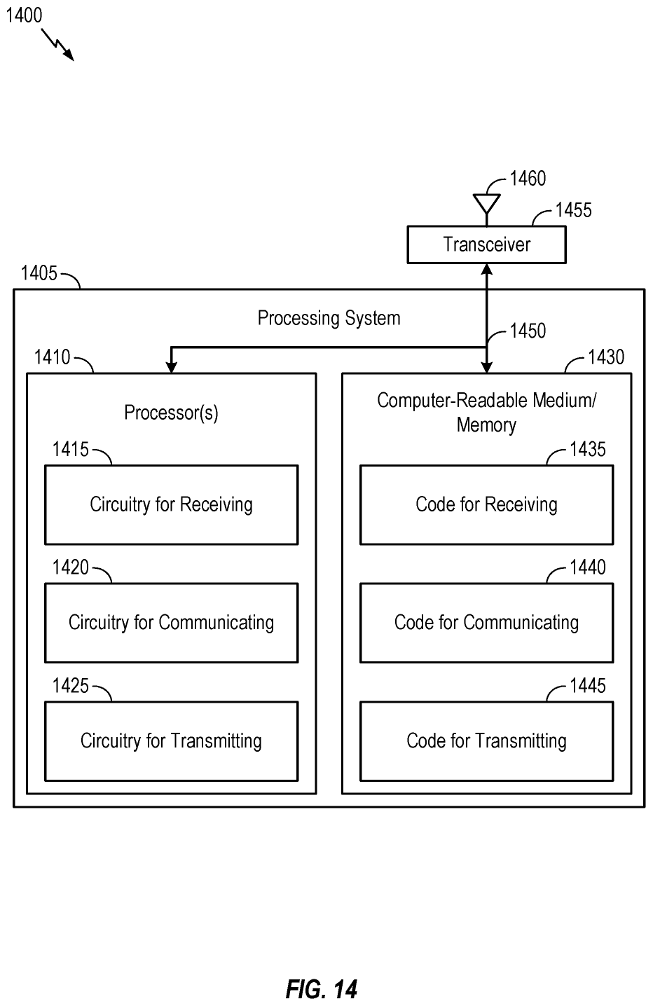

Method 1200 begins at step 1205 with receiving signaling indicating a plurality of non-contiguous subbands configured for a virtual cell. In some cases, the operations of this step refer to, or may be performed by, circuitry for receiving and/or code for receiving as described with reference to FIG. 14.

Method 1200 then proceeds to step 1210 with communicating in the virtual cell via the non-contiguous subbands. In some cases, the operations of this step refer to, or may be performed by, circuitry for communicating and/or code for communicating as described with reference to FIG. 14.

In some aspects, the non-contiguous subbands are part of at least one of: an uplink bandwidth part (BWP) or a downlink BWP configured on the virtual cell.

In some aspects, a configuration of the uplink BWP or the downlink BWP comprises a bitmap; each bit of the bitmap corresponds to a subband of the non-contiguous subbands configured for the virtual cell; a first value of each bit indicates a corresponding subband is configured for the BWP; and a second value of each bit indicates the corresponding subband is not configured for the BWP.

In some aspects, a configuration of the uplink BWP or the downlink BWP comprises a first indication of a first subband and a second indication of a second subband; and the first subband, the second subband, and all subbands with indices between a first index of the first subband and a second index of the second subband are configured for the BWP.

In some aspects, the signaling comprises system information (S1) which indicates a location, bandwidth, and index of the subbands configured for the virtual cell on downlink, uplink, or both downlink and uplink.

In some aspects, communicating in the virtual cell comprises: receiving a downlink control information (DCI) comprising a frequency domain resource allocation (FDRA) field, wherein the FDRA field indicates one or more frequency allocations in the plurality of non-contiguous subbands for a communication to or from the UE.

In some aspects, communicating in the virtual cell comprises: receiving a downlink control information (DCI) comprising a plurality of frequency domain resource allocation (FDRA) fields, wherein each FDRA field indicates one or more frequency allocations in a corresponding subband, of the plurality of non-contiguous subbands, for a communication to or from the UE.

In some aspects, communicating in the virtual cell comprises: transmitting a physical random access channel (PRACH) configured for a contention-based or a contention-free random access procedure on a first subband, of the plurality of non-contiguous subbands; and receiving a random access response (RAR) based on a random access radio network temporary identifier (RA-RNTI), a message B radio network temporary identifier (msgB-RNTI), or a cell radio network temporary identifier (C-RNTI) determined based on the PRACH transmission in the first subband.

In some aspects, receiving the RAR comprises: receiving a downlink control information (DCI) addressed to the RA-RNTI, msgB-RNTI, or C-RNTI on a second subband of the plurality of non-contiguous subbands; and receiving a transport block of the RAR which is mapped to a downlink data channel on a third subband, of the plurality of non-contiguous subbands, indicated by the DCI.

In some aspects, the method 1200 further includes transmitting an uplink transmission according to a timing advance command, a temporary C-RNTI (TC-RNTI), and an uplink grant in the RAR. In some cases, the operations of this step refer to, or may be performed by, circuitry for transmitting and/or code for transmitting as described with reference to FIG. 14.

In some aspects, the method 1200 further includes receiving, on a second subband of the plurality of non-contiguous subbands, a downlink control information (DCI) addressed to the TC-RNTI or the C-RNTI. In some cases, the operations of this step refer to, or may be performed by, circuitry for receiving and/or code for receiving as described with reference to FIG. 14.

In some aspects, the method 1200 further includes receiving a contention resolution message on a third subband or a fourth subband, of the plurality of non-contiguous subbands, indicated by the DCI. In some cases, the operations of this step refer to, or may be performed by, circuitry for receiving and/or code for receiving as described with reference to FIG. 14.

In some aspects, communicating in the virtual cell comprises: receiving a reference signal (RS) on a first subband of the plurality of non-contiguous subbands; receiving a source RS on a second subband of the plurality of non-contiguous subbands; and measuring the RS on the first subband based on the RS on the first subband being quasi co-located (QCL) with the source RS on the second subband.

In some aspects, the method 1200 further includes receiving, from a network entity, a downlink (DL) signal via one or more first subbands of an active DL bandwidth part (BWP) of the virtual cell. In some cases, the operations of this step refer to, or may be performed by, circuitry for receiving and/or code for receiving as described with reference to FIG. 14.

In some aspects, the method 1200 further includes transmitting, to the network entity, an uplink (UL) signal via one or more second subbands of an active UL BWP of the virtual cell, wherein the active DL BWP and the active UL BWP comprise spectrum resources that are at least one of: refarmed from a legacy radio access technology (RAT) or shared with a legacy RAT. In some cases, the operations of this step refer to, or may be performed by, circuitry for transmitting and/or code for transmitting as described with reference to FIG. 14.

In some aspects, the spectrum resources belong to at least one of: a frequency division duplex (FDD) band, a time division duplex (TDD), a supplementary DL (SDL) band, or a supplementary UL (SUL) band.

In some aspects, communicating in the virtual cell comprises: receiving a configuration of at least one of: a first uplink (UL) bandwidth part (BWP) or a first downlink (DL) BWP configured on the virtual cell; communicating in a half-duplex (HD) mode via at least one of the first UL BWP or the first DL BWP; receiving another configuration of at least one of: a second UL BWP or a second DL BWP configured on the virtual cell; and communicating in a full-duplex (FD) mode via at least one of the second UL BWP or the second DL BWP, based on the other configuration, wherein the HD mode or the FD mode are at least one of: jointly configured with the corresponding first UL BWP, first DL BWP, second UL BWP, or second DL BWP, or separately indicated to the UE after the corresponding first UL BWP configuration, first DL BWP configuration, second UL BWP configuration, or second DL BWP configuration.

In some aspects, communicating in the virtual cell comprises: receiving a configuration of at least one of: a first uplink (UL) bandwidth part (BWP) or a first downlink (DL) BWP configured on the virtual cell; and reporting a capability to communicate in a full-duplex (FD) mode, based on the configuration.

In some aspects, communicating in the virtual cell comprises: receiving a configuration of at least one of: a first uplink (UL) bandwidth part (BWP) or a first downlink (DL) BWP configured on the virtual cell; and reporting a capability to communicate in a first half-duplex (HD) mode or a second HD mode, based on the configuration.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

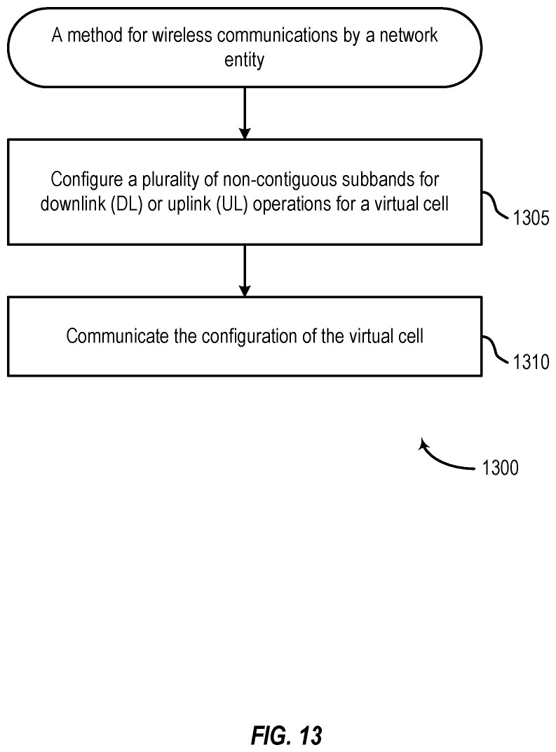

FIG. 13 shows an example of a method 1300 of wireless communications by a network entity, such as a BS 102 of FIGS. 1 and 3, or a disaggregated base station as discussed with respect to FIG. 2.

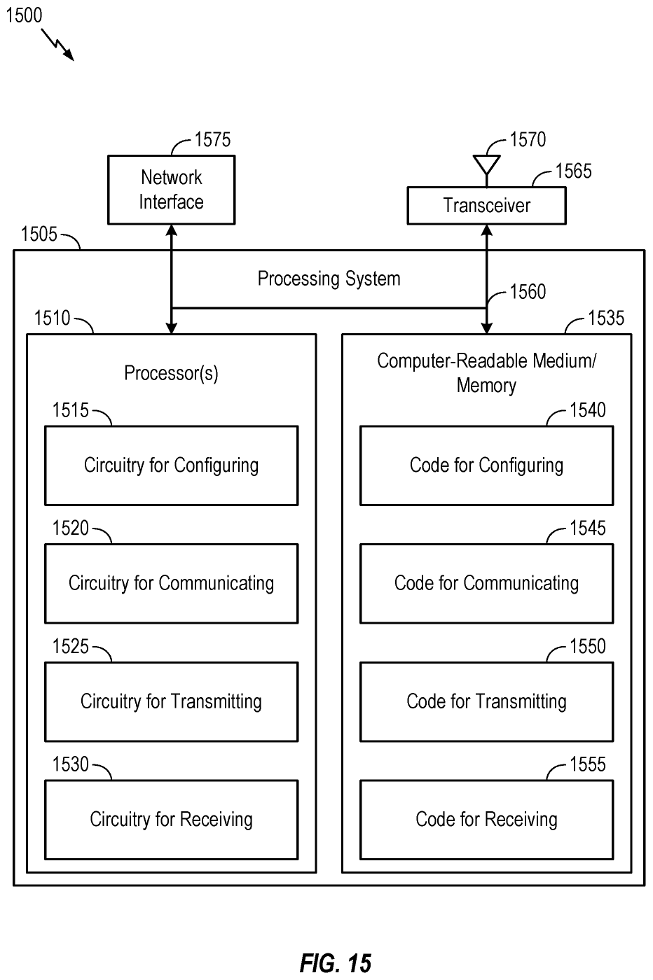

Method 1300 begins at step 1305 with configuring a plurality of non-contiguous subbands for downlink (DL) or uplink (UL) operations for a virtual cell. In some cases, the operations of this step refer to, or may be performed by, circuitry for configuring and/or code for configuring as described with reference to FIG. 15.

Method 1300 then proceeds to step 1310 with communicating the configuration of the virtual cell. In some cases, the operations of this step refer to, or may be performed by, circuitry for communicating and/or code for communicating as described with reference to FIG. 15.

In some aspects, each of the plurality of non-contiguous subbands belongs to a same frequency range as every other of the plurality of non-contiguous subbands.

In some aspects, a frequency gap between a subband of the non-contiguous subbands and a next subband of the non-contiguous subbands is less than a threshold, FMGAP.

In some aspects, a total of all bandwidths of all of the non-contiguous subbands is less than a threshold, F_{MSUM}.

In some aspects, the method 1300 further includes transmitting a physical channel or reference signal (RS) on two or more subbands of the non-contiguous subbands using a same sub-carrier spacing (SCS), a same cyclic prefix (CP), and a same waveform on the two or more subbands. In some cases, the operations of this step refer to, or may be performed by, circuitry for transmitting and/or code for transmitting as described with reference to FIG. 15.

In some aspects, a receive time difference (RTD) of a downlink channel or reference signal transmitted on two or more subbands of the non-contiguous subbands in the virtual cell is less than a threshold, T_{MRTD}; T_{CP} is a time duration of a cyclic prefix (CP) length associated with a reference or maximum sub-carrier spacing (SCS) supported by the virtual cell; L is an integer greater than 1 that is associated with the reference or maximum SCS supported by the virtual cell; and T_{MRTD} is less than T_{CP}/L.

In some aspects, the method 1300 further includes transmitting one or more timing advance (TA) commands for the non-contiguous subbands to a user equipment (UE) communicating in the virtual cell. In some cases, the operations of this step refer to, or may be performed by, circuitry for transmitting and/or code for transmitting as described with reference to FIG. 15.

In some aspects, the method 1300 further includes transmitting a downlink (DL) reference signal (RS) on two or more subbands of the non-contiguous subbands, wherein a difference of an average reception power of the two or more subbands is less than a threshold, P_{MRPD}. In some cases, the operations of this step refer to, or may be performed by, circuitry for transmitting and/or code for transmitting as described with reference to FIG. 15.

In some aspects, the method 1300 further includes transmitting, to a user equipment (UE), a downlink (DL) signal via one or more first subbands of the non-contiguous subbands. In some cases, the operations of this step refer to, or may be performed by, circuitry for transmitting and/or code for transmitting as described with reference to FIG. 15.

In some aspects, the method 1300 further includes receiving, from the UE and simultaneously with the transmitting, an uplink (UL) signal via one or more second subbands of the non-contiguous subbands. In some cases, the operations of this step refer to, or may be performed by, circuitry for receiving and/or code for receiving as described with reference to FIG. 15.

In some aspects, configuring the plurality of non-contiguous subbands comprises configuring a duplexing frequency gap between the first subbands and the second subbands.

In some aspects, the duplexing frequency gap is created and reserved for another network entity or another RAT.

In some aspects, the method 1300 further includes configuring at least one of: a first uplink (UL) bandwidth part (BWP) or a first downlink (DL) BWP configured on the virtual cell. In some cases, the operations of this step refer to, or may be performed by, circuitry for configuring and/or code for configuring as described with reference to FIG. 15.

In some aspects, the method 1300 further includes communicating with a user equipment (UE) in a half-duplex (HD) mode via at least one of the first UL BWP or the first DL BWP. In some cases, the operations of this step refer to, or may be performed by, circuitry for communicating and/or code for communicating as described with reference to FIG. 15.

In some aspects, the method 1300 further includes configuring at least one of: a second UL BWP or a second DL BWP configured on the virtual cell. In some cases, the operations of this step refer to, or may be performed by, circuitry for configuring and/or code for configuring as described with reference to FIG. 15.

In some aspects, the method 1300 further includes communicating with the UE in a full-duplex (FD) mode via at least one of the second UL BWP or the second DL BWP, based on the configuring of the at least one of the second UL BWP or the second DL BWP. In some cases, the operations of this step refer to, or may be performed by, circuitry for communicating and/or code for communicating as described with reference to FIG. 15.

In some aspects, the method 1300 further includes configuring a first uplink (UL) bandwidth part (BWP) and a first downlink (DL) BWP configured on the virtual cell, wherein a frequency gap is between the first UL BWP and the first DL BWP. In some cases, the operations of this step refer to, or may be performed by, circuitry for configuring and/or code for configuring as described with reference to FIG. 15.

In some aspects, the method 1300 further includes communicating with a user equipment (UE) in a full-duplex (FD) mode via at least one of the first UL BWP or the first DL BWP, based on the frequency gap not being reserved for transmissions of a radio access technology (RAT) of the network entity or another RAT. In some cases, the operations of this step refer to, or may be performed by, circuitry for communicating and/or code for communicating as described with reference to FIG. 15.

In some aspects, the non-contiguous subbands are part of at least one of: an uplink bandwidth part (BWP) or a downlink BWP configured on the virtual cell.

In some aspects, a configuration of the uplink BWP or the downlink BWP comprises a bitmap; each bit of the bitmap corresponds to a subband of the non-contiguous subbands configured for the virtual cell; a first value of each bit indicates a corresponding subband is configured for the BWP; and a second value of each bit indicates the corresponding subband is not configured for the BWP.

In some aspects, a configuration of the uplink BWP or the downlink BWP comprises a first indication of a first subband and a second indication of a second subband; and the first subband, the second subband, and all subbands with indices between a first index of the first subband and a second index of the second subband are configured for the BWP.

In some aspects, communicating the configuration comprises transmitting signaling indicating the plurality of non-contiguous subbands, wherein the signaling comprises system information (S1) which indicates a location, bandwidth, and index of the subbands configured for the virtual cell on downlink, uplink, or both downlink and uplink.

In some aspects, the method 1300 further includes transmitting a downlink control information (DCI) comprising a frequency domain resource allocation (FDRA) field, wherein the FDRA field indicates one or more frequency allocations in the plurality of non-contiguous subbands for a communication to or from the network entity. In some cases, the operations of this step refer to, or may be performed by, circuitry for transmitting and/or code for transmitting as described with reference to FIG. 15.

In some aspects, the method 1300 further includes transmitting a downlink control information (DCI) comprising a plurality of frequency domain resource allocation (FDRA) fields, wherein each FDRA field indicates one or more frequency allocations in a corresponding subband, of the plurality of non-contiguous subbands, for a communication to or from the network entity. In some cases, the operations of this step refer to, or may be performed by, circuitry for transmitting and/or code for transmitting as described with reference to FIG. 15.

In some aspects, the method 1300 further includes receiving a physical random access channel (PRACH) configured for a contention-based or a contention-free random access procedure on a first subband, of the plurality of non-contiguous subbands. In some cases, the operations of this step refer to, or may be performed by, circuitry for receiving and/or code for receiving as described with reference to FIG. 15.

In some aspects, the method 1300 further includes transmitting a random access response (RAR) based on a random access radio network temporary identifier (RA-RNTI), a message B radio network temporary identifier (msgB-RNTI), or a cell radio network temporary identifier (C-RNTI) determined based on the PRACH transmission in the first subband. In some cases, the operations of this step refer to, or may be performed by, circuitry for transmitting and/or code for transmitting as described with reference to FIG. 15.

In some aspects, transmitting the RAR comprises: transmitting a downlink control information (DCI) addressed to the RA-RNTI, msgB-RNTI, or C-RNTI on a second subband of the plurality of non-contiguous subbands; and transmitting a transport block of the RAR which is mapped to a downlink data channel on a third subband, of the plurality of non-contiguous subbands, indicated by the DCI.

In some aspects, the method 1300 further includes receiving an uplink transmission according to a timing advance command, a temporary C-RNTI (TC-RNTI), and an uplink grant in the RAR. In some cases, the operations of this step refer to, or may be performed by, circuitry for receiving and/or code for receiving as described with reference to FIG. 15.

In some aspects, the method 1300 further includes transmitting, on a second subband of the plurality of non-contiguous subbands, a downlink control information (DCI) addressed to the TC-RNTI or the C-RNTI. In some cases, the operations of this step refer to, or may be performed by, circuitry for transmitting and/or code for transmitting as described with reference to FIG. 15.

In some aspects, the method 1300 further includes transmitting a contention resolution message on a third subband or a fourth subband, of the plurality of non-contiguous subbands, indicated by the DCI. In some cases, the operations of this step refer to, or may be performed by, circuitry for transmitting and/or code for transmitting as described with reference to FIG. 15.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Communications Device(s)

FIG. 14 depicts aspects of an example communications device 1400. In some aspects, communications device 1400 is a user equipment, such as UE 104 described above with respect to FIGS. 1 and 3.

The communications device 1400 includes a processing system 1405 coupled to the transceiver 1455 (e.g., a transmitter and/or a receiver). The transceiver 1455 is configured to transmit and receive signals for the communications device 1400 via the antenna 1460, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1430 via a bus 1450. In certain aspects, the computer-readable medium/memory 1430 is configured to store instructions (e.g., computer-executable code) that when executed by the one or more processors 1410, cause the one or more processors 1410 to perform the method 1200 described with respect to FIG. 12, or any aspect related to it. Note that reference to a processor performing a function of communications device 1400 may include one or more processors 1410 performing that function of communications device 1400.

In the depicted example, computer-readable medium/memory 1430 stores code (e.g., executable instructions), such as code for receiving 1435, code for communicating 1440, and code for transmitting 1445. Processing of the code for receiving 1435, code for communicating 1440, and code for transmitting 1445 may cause the communications device 1400 to perform the method 1200 described with respect to FIG. 12, or any aspect related to it.

The one or more processors 1410 include circuitry configured to implement (e.g., execute) the code stored in the computer-readable medium/memory 1430, including circuitry such as circuitry for receiving 1415, circuitry for communicating 1420, and circuitry for transmitting 1425. Processing with circuitry for receiving 1415, circuitry for communicating 1420, and circuitry for transmitting 1425 may cause the communications device 1400 to perform the method 1200 described with respect to FIG. 12, or any aspect related to it.

Various components of the communications device 1400 may provide means for performing the method 1200 described with respect to FIG. 12, or any aspect related to it. For example, means for transmitting, sending, or outputting for transmission may include transceivers 354 and/or antenna(s) 352 of the UE 104 illustrated in FIG. 3 and/or the transceiver 1455 and the antenna 1460 of the communications device 1400 in FIG. 14. Means for receiving or obtaining may include transceivers 354 and/or antenna(s) 352 of the UE 104 illustrated in FIG. 3 and/or the transceiver 1455 and the antenna 1460 of the communications device 1400 in FIG. 14.

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to the transceiver 1565 (e.g., a transmitter and/or a receiver) and/or a network interface 1575. The transceiver 1565 is configured to transmit and receive signals for the communications device 1500 via the antenna 1570, such as the various signals as described herein. The network interface 1575 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1535 via a bus 1560. In certain aspects, the computer-readable medium/memory 1535 is configured to store instructions (e.g., computer-executable code) that when executed by the one or more processors 1510, cause the one or more processors 1510 to perform the method 1300 described with respect to FIG. 13, or any aspect related to it. Note that reference to a processor of communications device 1500 performing a function may include one or more processors 1510 of communications device 1500 performing that function.

In the depicted example, the computer-readable medium/memory 1535 stores code (e.g., executable instructions), such as code for configuring 1540, code for communicating 1545, code for transmitting 1550, and code for receiving 1555. Processing of the code for configuring 1540, code for communicating 1545, code for transmitting 1550, and code for receiving 1555 may cause the communications device 1500 to perform the method 1300 described with respect to FIG. 13, or any aspect related to it.

The one or more processors 1510 include circuitry configured to implement (e.g., execute) the code stored in the computer-readable medium/memory 1535, including circuitry such as circuitry for configuring 1515, circuitry for communicating 1520, circuitry for transmitting 1525, and circuitry for receiving 1530. Processing with circuitry for configuring 1515, circuitry for communicating 1520, circuitry for transmitting 1525, and circuitry for receiving 1530 may cause the communications device 1500 to perform the method 1300 described with respect to FIG. 13, or any aspect related to it.

Various components of the communications device 1500 may provide means for performing the method 1300 described with respect to FIG. 13, or any aspect related to it. Means for transmitting, sending, or outputting for transmission may include transceivers 332 and/or antenna(s) 334 of the BS 102 illustrated in FIG. 3 and/or the transceiver 1565 and the antenna 1570 of the communications device 1500 in FIG. 15. Means for receiving or obtaining may include transceivers 332 and/or antenna(s) 334 of the BS 102 illustrated in FIG. 3 and/or the transceiver 1565 and the antenna 1570 of the communications device 1500 in FIG. 15.

### Example Clauses

Implementation examples are described in the following numbered clauses:

Clause 1: A method for wireless communications by a user equipment (UE), comprising: receiving signaling indicating a plurality of non-contiguous subbands configured for a virtual cell; and communicating in the virtual cell via the non-contiguous subbands.

Clause 2: The method of Clause 1, wherein the non-contiguous subbands are part of at least one of: an uplink bandwidth part (BWP) or a downlink BWP configured on the virtual cell.

Clause 3: The method of any one of Clauses 1-2, wherein the signaling comprises system information (S1) which indicates a location, bandwidth, and index of the subbands configured for the virtual cell on downlink, uplink, or both downlink and uplink.

Clause 4: The method of Clause 2, wherein: a configuration of the uplink BWP or the downlink BWP comprises a bitmap; each bit of the bitmap corresponds to a subband of the non-contiguous subbands configured for the virtual cell; a first value of each bit indicates a corresponding subband is configured for the BWP; and a second value of each bit indicates the corresponding subband is not configured for the BWP.

Clause 5: The method of Clause 2, wherein: a configuration of the uplink BWP or the downlink BWP comprises a first indication of a first subband and a second indication of a second subband; and the first subband, the second subband, and all subbands with indices between a first index of the first subband and a second index of the second subband are configured for the BWP.

Clause 6: The method of any one of Clauses 1-5, wherein communicating in the virtual cell comprises: receiving a downlink control information (DCI) comprising a frequency domain resource allocation (FDRA) field, wherein the FDRA field indicates one or more frequency allocations in the plurality of non-contiguous subbands for a communication to or from the UE.

Clause 7: The method of any one of Clauses 1-6, wherein communicating in the virtual cell comprises: receiving a downlink control information (DCI) comprising a plurality of frequency domain resource allocation (FDRA) fields, wherein each FDRA field indicates one or more frequency allocations in a corresponding subband, of the plurality of non-contiguous subbands, for a communication to or from the UE.

Clause 8: The method of any one of Clauses 1-7, wherein communicating in the virtual cell comprises: transmitting a physical random access channel (PRACH) configured for a contention-based or a contention-free random access procedure on a first subband, of the plurality of non-contiguous subbands; and receiving a random access response (RAR) based on a random access radio network temporary identifier (RA-RNTI), a message B radio network temporary identifier (msgB-RNTI), or a cell radio network temporary identifier (C-RNTI) determined based on the PRACH transmission in the first subband.

Clause 9: The method of Clause 8, wherein receiving the RAR comprises: receiving a downlink control information (DCI) addressed to the RA-RNTI, msgB-RNTI, or C-RNTI on a second subband of the plurality of non-contiguous subbands; and receiving a transport block of the RAR which is mapped to a downlink data channel on a third subband, of the plurality of non-contiguous subbands, indicated by the DCI.

Clause 10: The method of Clause 8, further comprising: transmitting an uplink transmission according to a timing advance command, a temporary C-RNTI (TC-RNTI), and an uplink grant in the RAR; receiving, on a second subband of the plurality of non-contiguous subbands, a downlink control information (DCI) addressed to the TC-RNTI or the C-RNTI; and receiving a contention resolution message on a third subband or a fourth subband, of the plurality of non-contiguous subbands, indicated by the DCI.

Clause 11: The method of any one of Clauses 1-10, wherein communicating in the virtual cell comprises: receiving a reference signal (RS) on a first subband of the plurality of non-contiguous subbands; receiving a source RS on a second subband of the plurality of non-contiguous subbands; and measuring the RS on the first subband based on the RS on the first subband being quasi co-located (QCL′d) with the source RS on the second subband.

Clause 12: The method of any one of Clauses 1-11, further comprising: receiving, from a network entity, a downlink (DL) signal via one or more first subbands of an active DL bandwidth part (BWP) of the virtual cell; and transmitting, to the network entity, an uplink (UL) signal via one or more second subbands of an active UL BWP of the virtual cell, wherein the active DL BWP and the active UL BWP comprise spectrum resources that are at least one of: refarmed from a legacy radio access technology (RAT) or shared with a legacy RAT.

Clause 13: The method of Clause 12, wherein the spectrum resources belong to at least one of: a frequency division duplex (FDD) band, a time division duplex (TDD), a supplementary DL (SDL) band, or a supplementary UL (SUL) band.

Clause 14: The method of any one of Clauses 1-13, wherein communicating in the virtual cell comprises: receiving a configuration of at least one of: a first uplink (UL) bandwidth part (BWP) or a first downlink (DL) BWP configured on the virtual cell; communicating in a half-duplex (HD) mode via at least one of the first UL BWP or the first DL BWP; receiving another configuration of at least one of: a second UL BWP or a second DL BWP configured on the virtual cell; and communicating in a full-duplex (FD) mode via at least one of the second UL BWP or the second DL BWP, based on the other configuration, wherein the HD mode or the FD mode are at least one of: jointly configured with the corresponding first UL BWP, first DL BWP, second UL BWP, or second DL BWP, or separately indicated to the UE after the corresponding first UL BWP configuration, first DL BWP configuration, second UL BWP configuration, or second DL BWP configuration.

Clause 15: The method of any one of Clauses 1-14, wherein communicating in the virtual cell comprises: receiving a configuration of at least one of: a first uplink (UL) bandwidth part (BWP) or a first downlink (DL) BWP configured on the virtual cell; and reporting a capability to communicate in a full-duplex (FD) mode, based on the configuration.

Clause 16: The method of any one of Clauses 1-15, wherein communicating in the virtual cell comprises: receiving a configuration of at least one of: a first uplink (UL) bandwidth part (BWP) or a first downlink (DL) BWP configured on the virtual cell; and reporting a capability to communicate in a first half-duplex (HD) mode or a second HD mode, based on the configuration.

Clause 17: A method for wireless communications by a network entity, comprising: configuring a plurality of non-contiguous subbands for downlink (DL) or uplink (UL) operations for a virtual cell; and communicating the configuration of the virtual cell.

Clause 18: The method of Clause 17, wherein each of the plurality of non-contiguous subbands belongs to a same frequency range as every other of the plurality of non-contiguous subbands.

Clause 19: The method of any one of Clauses 17-18, wherein a frequency gap between a subband of the non-contiguous subbands and a next subband of the non-contiguous subbands is less than a threshold, FMGAP.

Clause 20: The method of any one of Clauses 17-19, wherein a total of all bandwidths of all of the non-contiguous subbands is less than a threshold, F_{MSUM}.

Clause 21: The method of any one of Clauses 17-20, further comprising: transmitting a physical channel or reference signal (RS) on two or more subbands of the non-contiguous subbands using a same sub-carrier spacing (SCS), a same cyclic prefix (CP), and a same waveform on the two or more subbands.

Clause 22: The method of any one of Clauses 17-21, wherein: a receive time difference (RTD) of a downlink channel or reference signal transmitted on two or more subbands of the non-contiguous subbands in the virtual cell is less than a threshold, T_{MRTD}; T_{CP} is a time duration of a cyclic prefix (CP) length associated with a reference or maximum sub-carrier spacing (SCS) supported by the virtual cell; L is an integer greater than 1 that is associated with the reference or maximum SCS supported by the virtual cell; and T_{MRTD} is less than T_{CP}/L.

Clause 23: The method of any one of Clauses 17-22, further comprising: transmitting one or more timing advance (TA) commands for the non-contiguous subbands to a user equipment (UE) communicating in the virtual cell.

Clause 24: The method of any one of Clauses 17-23, further comprising: transmitting a downlink (DL) reference signal (RS) on two or more subbands of the non-contiguous subbands, wherein a difference of an average reception power of the two or more subbands is less than a threshold, P_{MRPD}.

Clause 25: The method of any one of Clauses 17-24, further comprising: transmitting, to a user equipment (UE), a downlink (DL) signal via one or more first subbands of the non-contiguous subbands; and receiving, from the UE and simultaneously with the transmitting, an uplink (UL) signal via one or more second subbands of the non-contiguous subbands.

Clause 26: The method of Clause 25, wherein configuring the plurality of non-contiguous subbands comprises configuring a duplexing frequency gap between the first subbands and the second subbands.

Clause 27: The method of Clause 26, wherein the duplexing frequency gap is created and reserved for another network entity or another RAT.

Clause 28: The method of any one of Clauses 17-27, further comprising: configuring at least one of: a first uplink (UL) bandwidth part (BWP) or a first downlink (DL) BWP configured on the virtual cell; communicating with a user equipment (UE) in a half-duplex (HD) mode via at least one of the first UL BWP or the first DL BWP; configuring at least one of: a second UL BWP or a second DL BWP configured on the virtual cell; and communicating with the UE in a full-duplex (FD) mode via at least one of the second UL BWP or the second DL BWP, based on the configuring of the at least one of the second UL BWP or the second DL BWP.

Clause 29: The method of any one of Clauses 17-28, further comprising: configuring a first uplink (UL) bandwidth part (BWP) and a first downlink (DL) BWP configured on the virtual cell, wherein a frequency gap is between the first UL BWP and the first DL BWP; and communicating with a user equipment (UE) in a full-duplex (FD) mode via at least one of the first UL BWP or the first DL BWP, based on the frequency gap not being reserved for transmissions of a radio access technology (RAT) of the network entity or another RAT.

Clause 30: The method of any one of Clauses 17-29, wherein the non-contiguous subbands are part of at least one of: an uplink bandwidth part (BWP) or a downlink BWP configured on the virtual cell.

Clause 31: The method of any one of Clauses 17-30, wherein communicating the configuration comprises transmitting signaling indicating the plurality of non-contiguous subbands, wherein the signaling comprises system information (S1) which indicates a location, bandwidth, and index of the subbands configured for the virtual cell on downlink, uplink, or both downlink and uplink.

Clause 32: The method of Clause 30, wherein: a configuration of the uplink BWP or the downlink BWP comprises a bitmap; each bit of the bitmap corresponds to a subband of the non-contiguous subbands configured for the virtual cell; a first value of each bit indicates a corresponding subband is configured for the BWP; and a second value of each bit indicates the corresponding subband is not configured for the BWP.

Clause 33: The method of Clause 30, wherein: a configuration of the uplink BWP or the downlink BWP comprises a first indication of a first subband and a second indication of a second subband; and the first subband, the second subband, and all subbands with indices between a first index of the first subband and a second index of the second subband are configured for the BWP.

Clause 34: The method of any one of Clauses 17-33, further comprising: transmitting a downlink control information (DCI) comprising a frequency domain resource allocation (FDRA) field, wherein the FDRA field indicates one or more frequency allocations in the plurality of non-contiguous subbands for a communication to or from the network entity.

Clause 35: The method of any one of Clauses 17-34, further comprising: transmitting a downlink control information (DCI) comprising a plurality of frequency domain resource allocation (FDRA) fields, wherein each FDRA field indicates one or more frequency allocations in a corresponding subband, of the plurality of non-contiguous subbands, for a communication to or from the network entity.

Clause 36: The method of any one of Clauses 17-35, further comprising: receiving a physical random access channel (PRACH) configured for a contention-based or a contention-free random access procedure on a first subband, of the plurality of non-contiguous subbands; and transmitting a random access response (RAR) based on a random access radio network temporary identifier (RA-RNTI), a message B radio network temporary identifier (msgB-RNTI), or a cell radio network temporary identifier (C-RNTI) determined based on the PRACH transmission in the first subband.

Clause 37: The method of Clause 36, wherein transmitting the RAR comprises: transmitting a downlink control information (DCI) addressed to the RA-RNTI, msgB-RNTI, or C-RNTI on a second subband of the plurality of non-contiguous subbands; and transmitting a transport block of the RAR which is mapped to a downlink data channel on a third subband, of the plurality of non-contiguous subbands, indicated by the DCI.

Clause 38: The method of Clause 37, further comprising: receiving an uplink transmission according to a timing advance command, a temporary C-RNTI (TC-RNTI), and an uplink grant in the RAR; transmitting, on a second subband of the plurality of non-contiguous subbands, a downlink control information (DCI) addressed to the TC-RNTI or the C-RNTI; and transmitting a contention resolution message on a third subband or a fourth subband, of the plurality of non-contiguous subbands, indicated by the DCI.

Clause 39: An apparatus, comprising: a memory comprising executable instructions; and a processor configured to execute the executable instructions and cause the apparatus to perform a method in accordance with any one of Clauses 1-38.

Clause 40: An apparatus, comprising means for performing a method in accordance with any one of Clauses 1-38.

Clause 41: A non-transitory computer-readable medium comprising executable instructions that, when executed by a processor of an apparatus, cause the apparatus to perform a method in accordance with any one of Clauses 1-38.

Clause 42: A computer program product embodied on a computer-readable storage medium comprising code for performing a method in accordance with any one of Clauses 1-38.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising:
at least one memory comprising computer-executable instructions; and
one or more processors configured to execute the computer-executable instructions and cause the UE to:
receive signaling indicating a plurality of non-contiguous subbands configured for a virtual cell; and
communicate in the virtual cell via the non-contiguous subbands.

2. The apparatus of claim 1, wherein the non-contiguous subbands are part of at least one of: an uplink bandwidth part (BWP) or a downlink BWP configured on the virtual cell.

3. The apparatus of claim 1, wherein the signaling comprises system information (S1) which indicates a location, bandwidth, and index of the subbands configured for the virtual cell on downlink, uplink, or both downlink and uplink.

4. The apparatus of claim 2, wherein:
a configuration of the uplink BWP or the downlink BWP comprises a bitmap;
each bit of the bitmap corresponds to a subband of the non-contiguous subbands configured for the virtual cell;
a first value of each bit indicates a corresponding subband is configured for the BWP; and
a second value of each bit indicates the corresponding subband is not configured for the BWP.

5. The apparatus of claim 2, wherein:
a configuration of the uplink BWP or the downlink BWP comprises a first indication of a first subband and a second indication of a second subband; and
the first subband, the second subband, and all subbands with indices between a first index of the first subband and a second index of the second subband are configured for the BWP.

6. The apparatus of claim 1, wherein communicating in the virtual cell comprises:
receiving a downlink control information (DCI) comprising at least one of:
a frequency domain resource allocation (FDRA) field, wherein the FDRA field indicates one or more frequency allocations in the plurality of non-contiguous subbands for a communication to or from the UE; or
a plurality of frequency domain resource allocation (FDRA) fields, wherein each FDRA field indicates one or more frequency allocations in a corresponding subband, of the plurality of non-contiguous subbands, for a communication to or from the UE.

7. The apparatus of claim 1, wherein communicating in the virtual cell comprises:
transmitting a physical random access channel (PRACH) configured for a contention-based or a contention-free random access procedure on a first subband, of the plurality of non-contiguous subbands; and
receiving a random access response (RAR) based on at least one of a random access radio network temporary identifier (RA-RNTI), a message B radio network temporary identifier (msgB-RNTI), or a cell radio network temporary identifier (C-RNTI) determined based on the PRACH transmission in the first subband.

8. The apparatus of claim 7, wherein receiving the RAR comprises:
receiving a downlink control information (DCI) addressed to the RA-RNTI, msgB-RNTI, or C-RNTI on a second subband of the plurality of non-contiguous subbands; and
receiving a transport block of the RAR which is mapped to a downlink data channel on a third subband, of the plurality of non-contiguous subbands, indicated by the DCI.

9. The apparatus of claim 7, wherein the one or more processors are further configured to cause the UE to:
transmit an uplink transmission according to a timing advance command, a temporary C-RNTI (TC-RNTI), and an uplink grant in the RAR;
receive, on a second subband of the plurality of non-contiguous subbands, a downlink control information (DCI) addressed to the TC-RNTI or the C-RNTI; and
receive a contention resolution message on the second subband or a third subband, of the plurality of non-contiguous subbands, indicated by the DCI.

10. The apparatus of claim 1, wherein communicating in the virtual cell comprises:
receiving a reference signal (RS) on a first subband of the plurality of non-contiguous subbands;
receiving a source RS on a second subband of the plurality of non-contiguous subbands; and
measuring the RS on the first subband based on the RS on the first subband being quasi co-located (QCL'd) with the source RS on the second subband.

11. The apparatus of claim 1, wherein the one or more processors are further configured to cause the UE to:
receive, from a network entity, a downlink (DL) signal via one or more first subbands of an active DL bandwidth part (BWP) of the virtual cell; and
transmit, to the network entity, an uplink (UL) signal via one or more second subbands of an active UL BWP of the virtual cell, wherein the active DL BWP and the active UL BWP comprise spectrum resources that are at least one of: refarmed from a legacy radio access technology (RAT) or shared with a legacy RAT.

12. The apparatus of claim 1, wherein communicating in the virtual cell comprises:
receiving a configuration of at least one of: a first uplink (UL) bandwidth part (BWP) or a first downlink (DL) BWP configured on the virtual cell;
communicating in a half-duplex (HD) mode via at least one of the first UL BWP or the first DL BWP;
receiving another configuration of at least one of: a second UL BWP or a second DL BWP configured on the virtual cell; and
communicating in a full-duplex (FD) mode via at least one of the second UL BWP or the second DL BWP, based on the other configuration, wherein the HD mode or the FD mode are at least one of:
jointly configured with the corresponding first UL BWP, first DL BWP, second UL BWP, or second DL BWP, or
separately indicated to the UE after the corresponding first UL BWP configuration, first DL BWP configuration, second UL BWP configuration, or second DL BWP configuration.

13. The apparatus of claim 1, wherein communicating in the virtual cell comprises:
receiving a configuration of at least one of: a first uplink (UL) bandwidth part (BWP) or a first downlink (DL) BWP configured on the virtual cell; and
reporting a capability to communicate in a full-duplex (FD) mode, based on the configuration.

14. The apparatus of claim 1, wherein communicating in the virtual cell comprises:
receiving a configuration of at least one of: a first uplink (UL) bandwidth part (BWP) or a first downlink (DL) BWP configured on the virtual cell; and
reporting a capability to communicate in a first half-duplex (HD) mode or a second HD mode, based on the configuration.

15. An apparatus for wireless communications at a network entity, comprising:
at least one memory comprising computer-executable instructions; and
one or more processors configured to execute the computer-executable instructions and cause the network entity to:
configure a plurality of non-contiguous subbands for downlink (DL) or uplink (UL) operations for a virtual cell; and
communicate the configuration of the virtual cell.

16. The apparatus of claim 15, wherein the one or more processors are further configured to cause the network entity to:
transmit a physical channel or reference signal (RS) on two or more subbands of the non-contiguous subbands using a same sub-carrier spacing (SCS), a same cyclic prefix (CP), and a same waveform on the two or more subbands.

17. The apparatus of claim 15, wherein:
a receive time difference (RTD) of a downlink channel or reference signal transmitted on two or more subbands of the non-contiguous subbands in the virtual cell is less than a threshold, T_{MRTD};
T_{CP} is a time duration of a cyclic prefix (CP) length associated with a reference or maximum sub-carrier spacing (SCS) supported by the virtual cell;
L is an integer greater than 1 that is associated with the reference or maximum SCS supported by the virtual cell; and
T_{MRTD} is less than T_{CP}/L.

18. The apparatus of claim 15, wherein the one or more processors are further configured to cause the network entity to:
transmit one or more timing advance (TA) commands for the non-contiguous subbands to a user equipment (UE) communicating in the virtual cell.

19. The apparatus of claim 15, wherein the one or more processors are further configured to cause the network entity to:
transmit, to a user equipment (UE), a downlink (DL) signal via one or more first subbands of the non-contiguous subbands; and
receive, from the UE and simultaneously with the transmitting, an uplink (UL) signal via one or more second subbands of the non-contiguous subbands.

20. The apparatus of claim 19, wherein configuring the plurality of non-contiguous subbands comprises configuring a duplexing frequency gap between the first subbands and the second subbands.

21. The apparatus of claim 15, wherein the one or more processors are further configured to cause the network entity to:
configure at least one of: a first uplink (UL) bandwidth part (BWP) or a first downlink (DL) BWP configured on the virtual cell;
communicate with a user equipment (UE) in a half-duplex (HD) mode via at least one of the first UL BWP or the first DL BWP;
configure at least one of: a second UL BWP or a second DL BWP configured on the virtual cell; and
communicate with the UE in a full-duplex (FD) mode via at least one of the second UL BWP or the second DL BWP, based on the configuring of the at least one of the second UL BWP or the second DL BWP.

22. The apparatus of claim 15, wherein the one or more processors are further configured to cause the network entity to:
configure a first uplink (UL) bandwidth part (BWP) and a first downlink (DL) BWP on the virtual cell, wherein a frequency gap is between the first UL BWP and the first DL BWP; and
communicate with a user equipment (UE) in a full-duplex (FD) mode via at least one of the first UL BWP or the first DL BWP, based on the frequency gap not being reserved for transmissions of a radio access technology (RAT) of the network entity or another RAT.

23. The apparatus of claim 15, wherein communicating the configuration comprises transmitting signaling indicating the plurality of non-contiguous subbands, wherein the signaling comprises system information (S1) which indicates a location, bandwidth, and index of the subbands configured for the virtual cell on downlink, uplink, or both downlink and uplink.

24. The apparatus of claim 15, wherein:
the non-contiguous subbands are part of at least one of: an uplink bandwidth part (BWP) or a downlink BWP configured on the virtual cell;
a configuration of the uplink BWP or the downlink BWP comprises a bitmap;
each bit of the bitmap corresponds to a subband of the non-contiguous subbands configured for the virtual cell;
a first value of each bit indicates a corresponding subband is configured for the BWP; and
a second value of each bit indicates the corresponding subband is not configured for the BWP.

25. The apparatus of claim 15, wherein:
the non-contiguous subbands are part of at least one of: an uplink bandwidth part (BWP) or a downlink BWP configured on the virtual cell;
a configuration of the uplink BWP or the downlink BWP comprises a first indication of a first subband and a second indication of a second subband; and
the first subband, the second subband, and all subbands with indices between a first index of the first subband and a second index of the second subband are configured for the BWP.

26. The apparatus of claim 15, wherein the one or more processors are further configured to cause the network entity to:
transmit a downlink control information (DCI) comprising at least one of:
a frequency domain resource allocation (FDRA) field, wherein the FDRA field indicates one or more frequency allocations in the plurality of non-contiguous subbands for a communication to or from the network entity; or
a plurality of frequency domain resource allocation (FDRA) fields, wherein each FDRA field indicates one or more frequency allocations in a corresponding subband, of the plurality of non-contiguous subbands, for a communication to or from the network entity.

27. The apparatus of claim 15, wherein the one or more processors are further configured to cause the network entity to:
receive a physical random access channel (PRACH) configured for a contention-based or a contention-free random access procedure on a first subband, of the plurality of non-contiguous subbands; and
transmit a random access response (RAR) addressed to a random access radio network temporary identifier (RA-RNTI), a message B radio network temporary identifier (msgB-RNTI), or a cell radio network temporary identifier (C-RNTI) determined based on the PRACH transmission in the first subband.

28. The apparatus of claim 27, wherein:
transmitting the RAR comprises:
transmitting a downlink control information (DCI) addressed to the RA-RNTI, msgB-RNTI, or C-RNTI on a second subband of the plurality of non-contiguous subbands; and
transmitting a transport block of the RAR which is mapped to a downlink data channel on a third subband, of the plurality of non-contiguous subbands, indicated by the DCI; and
the one or more processors are further configured to cause the network entity to:
receive an uplink transmission according to a timing advance command, a temporary C-RNTI (TC-RNTI), and an uplink grant in the RAR;
transmit, on a second subband of the plurality of non-contiguous subbands, a downlink control information (DCI) addressed to the TC-RNTI or the C-RNTI; and
transmit a contention resolution message on the second subband or a third subband, of the plurality of non-contiguous subbands, indicated by the DCI.

29. A method for wireless communications by a user equipment (UE), comprising:
receiving signaling indicating a plurality of non-contiguous subbands configured for a virtual cell; and
communicating in the virtual cell via the non-contiguous subbands.

30. A method for wireless communications by a network entity, comprising:
configuring a plurality of non-contiguous subbands for downlink (DL) or uplink (UL) operations for a virtual cell; and
communicating the configuration of the virtual cell.
